(19) United States
(12) Patent Application Publication
(10) Pub. No.: US 2014/0100859 A1
(43) Pub. Date: Apr. 10, 2014

(54) Diet planning system and method

(71) Applicant: Mantian Zhu, Oakton, VA (US)

(72) Inventor: Mantian Zhu, Oakton, VA (US)

(21) Appl. No.: 13/645,420

(22) Filed: Oct. 4, 2012

(51) Int. Cl. G06Q 50/22

(52) U.S. Cl. 705/2

(57) ABSTRACT

A diet planning system and method that provide a user an electronic device for inputting food items that represent a partial diet menu for a time period. The system computes the difference between the nutritional values of the user specified food items and a pre-established user-specifiable set of target intake nutritional values. The system suggests food items, of which nutritional values match or are close to the difference computed above to complete the diet menu for the specified time period. The system then displays on the electronic device the complete diet menu comprising of the user specified and the system suggested food items for the time period. The system optionally displays the total nutritional values of the food items in the diet menu and the target intake nutritional values.

### RELATED APPLICATIONS

U.S. Patent Documents

| | | |
|---|---|---|
| 4,951,197 | August, 1990 | Mellinger |
| 6,083,006 | July, 2000 | Coffman |
| 6,283,914 | September, 2001 | Mansfield |
| 6,356,940 | March, 2002 | Short |
| 7,413,438 | August, 2008 | Bisogno |
| 7,788,113 | August, 2010 | Fuhrman, Levill |
| 8,117,176 | February, 2012 | Lee |

### FEDERALLY SPONSORED RESEARCH

Not Applicable

### JOINT RESEARCH AGREEMENT

Not Applicable

### MATERIAL SUBMITTED ON A COMPACT DISC

Not Applicable

### BACKGROUND

1. Field of Invention

This invention relates to a diet planning system and method for individuals with nutrition related interest or concern, such as weight loss or diabetes. More particularly, the present invention relates to a system and method for providing individuals the flexibility to freely choose food items as part of a diet menu while constructing a complete diet menu that satisfies one or more target intake nutritional values.

2. Description of Related Art

A system and method of assisting an individual to achieve a nutrition related goal such as weight loss provides a diet plan that is both flexible and structured.

Various systems exist to facilitate monitoring of nutrition content of food consumption. Existing systems, however, typically calculate the nutritional values of the consumables and provide the results to the user; they lack the capability to interactively suggest a complete diet menu that satisfies the target nutritional intake.

Existing diet programs typically provide a guideline or suggest a complete diet menu. They lack the flexibility for the user to freely choose part of the diet menu while still adhere to a set of targets.

Due to the above identified shortcomings in the existing art, a flexible and interactive diet planning system and method are needed for improving the user's probability of achieving a nutrition related goal.

### SUMMARY OF INVENTION

The present invention provides a diet planning method applied in a diet planning system for interactively accepting entries of food items as part of a diet menu, then suggesting a complete diet menu that adheres to a set of target nutritional values such that a user may enjoy the freedom of consuming desired food items while still achieve a nutrition related goal.

The user may specify by means of personal preference the target nutritional values for a time period, the favorite food categories for a meal, and the favorite food items in a food category. Thus, the user is able to adapt the system to reflect their own goals and eating preferences. For example, a vegetarian may set a target daily intake for calories at 1800 and choose vegetables, fruits, dairy, and desert as food categories for dinner and choose what their favorite vegetables are in the category. The same user can select food items for lunch and breakfast, the system shall suggest a dinner menu based on the above stated preferences.

Flexibility is identified as the key ingredient for the long term success of a diet plan and is the key advantage of the present invention. Other aspects and advantages of the present invention will become apparent from the following DETAILED DESCRIPTION OF A PREFERRED EMBODIMENT, taken in conjunction with the accompanying drawings.

### BRIEF DESCRIPTION OF THE DRAWINGS

FIG. 1 is a flow chart, which shows the steps included within a diet planning method; and

FIG. 2 is a schematic diagram of a diet planning system according to a preferred embodiment of the invention.

### DETAILED DESCRIPTION OF A PREFERRED EMBODIMENT

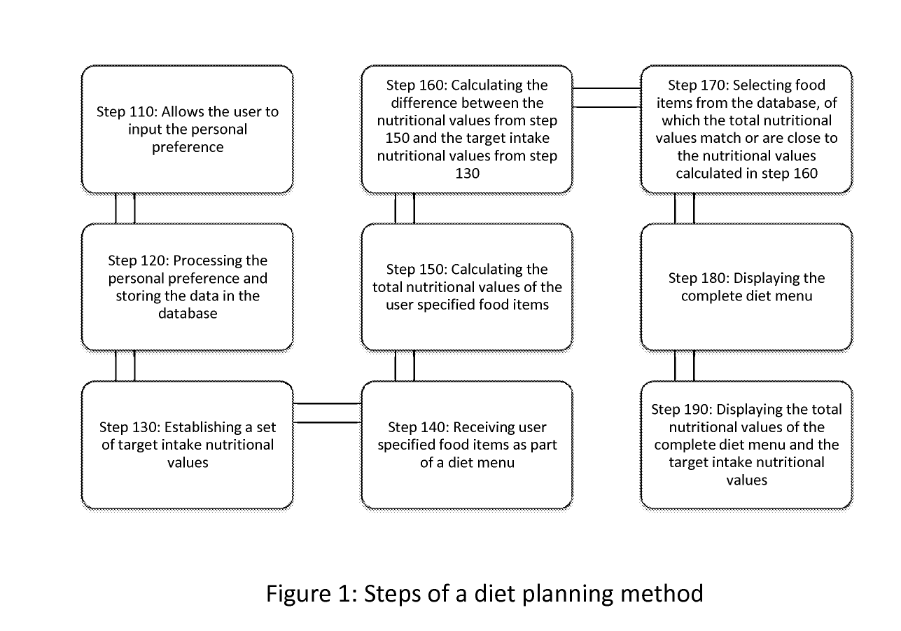

FIG. 1 shows a flow chart of the steps included within the diet planning method according to the invention.

Step 110 allows the user to input the personal preference.

Step 120 includes processing the personal preference and storing the data in the database.

Step 130 includes establishing a set of target intake nutritional values based on personal preference and authoritative standards.

Step 140 includes receiving user specified food items as part of a diet menu.

Step 150 includes calculating the total nutritional values of the user specified food items.

Step 160 includes calculating the difference between the nutritional values from step 150 and the target intake nutritional values from step 130.

Step 170 includes selecting food items from the database, of which the total nutritional values match or are close to the nutritional values calculated in step 160.

Step 180 includes displaying the complete diet menu consisting of user specified food items received from step 140 and those selected from step 170 on the remote electronic device.

Step 190 includes displaying the total nutritional values of all the food items in the complete diet menu and the target intake nutritional values.

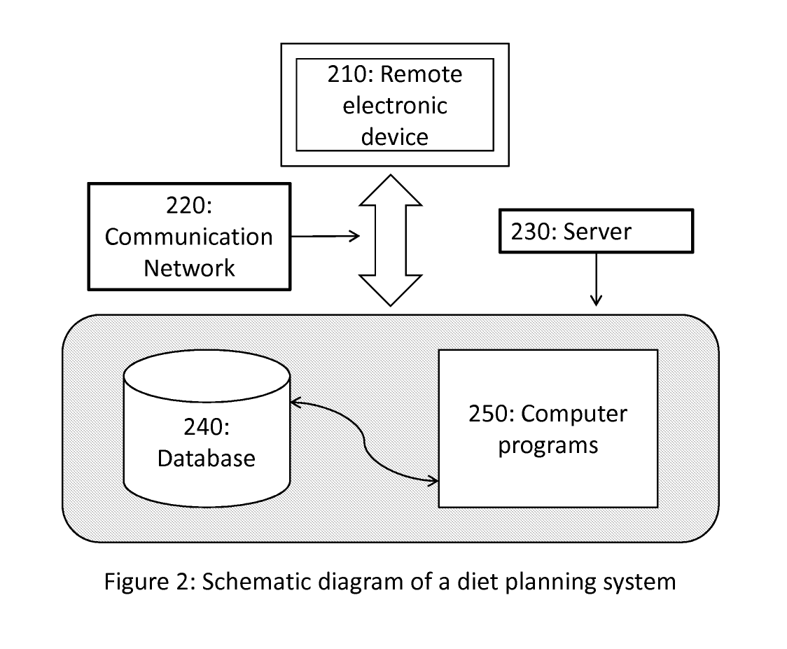

FIG. 2 is a schematic diagram of a diet planning system according to a preferred embodiment of the invention. In FIG. 2, the system includes a remote electronic device 210, a communication network 220, a server 230 hosting a database 240 and computer programs 250. The remote electronic device 210 can be a desktop computer, a laptop computer, a tablet computer, or a mobile phone. The communications network 220 can be wired, wireless, or both.

The remote electronic device 210 allows the user to input personal preferences, which are transmitted by the communication network 220 to the server 230; the computer programs 250 process the data and store the data in the database 240. The remote electronic device 210 displays the favorite food categories for breakfast, lunch and dinner and allows the user to select food items from the food categories as part of a diet menu for the day. The communication network transmits the user selections to the server 230. The computer programs 250 calculate the nutritional values of the user specified food items and the difference between the calculated values and the set of target daily intake nutritional values. The computer programs 250 select food items from the favorite food categories in the database 240, of which the nutritional values match or are close to the difference calculated above. The communication network 220 transmits the results back to the remote electronic device 210, which subsequently displays the complete diet menu for breakfast, lunch, and dinner. The electronic device 210 optionally displays the total nutritional values of the all the food items in the diet menu and the set of target daily intake nutritional values.

Although the present invention has been described and illustrated in relation to its preferred embodiment, it is understood that equivalents may be employed and substitutions made herein without departing from the scope of the invention as recited in the claims.

1) A diet planning method, which is applied in a diet planning system comprising a remote electronic device, a communication network, and a server hosting a database and computer programs, the method consisting the steps of:
a. receiving personal preference through the communication network from the remote electronic device;
b. processing and storing the personal preference in the database;
c. establishing a set of target intake nutritional values based on the personal preference and authoritative standards;
d. receiving user specified food items, which represent part of the diet menu for a time period through the communication network from the remote electronic device;
e. calculating the total nutritional values of the user specified food items;
f. calculating the difference between the nutritional values from step (e) and the target intake nutritional values from step (c);
g. selecting food items from the database, of which the total nutritional values match or are close to the nutritional values calculated in step (f);
h. displaying the complete diet menu consisting of user specified food items and those selected from step (g) on the remote electronic device;
i. optionally displaying the total nutritional values of all the food items in the complete diet menu and the target intake nutritional values. Note that once steps a, b, c are performed, subsequent use of the system may abbreviate these steps.

2) The method as claimed in claim 1, wherein the personal preference includes target intake value for calories.

3) The method as claimed in claim 1, wherein the personal preference includes target intake value for one or more macronutrients such as total fat, saturated fatty acids, cholesterol, sodium, potassium, total carbohydrate, dietary fiber, and protein.

4) The method as claimed in claim 1, wherein the personal preference includes target intake value for one or more vitamins and minerals.

5) The method as claimed in claim 1, wherein the personal preference includes preferred food categories for a meal.

6) The method as claimed in claim 1, wherein the personal preference includes preferred food items in a food category.

7) The method as claimed in claim 1, wherein the set of target intake nutritional values are based on the FDA Daily Reference Values for macronutrients and the FDA Recommended Dietary Allowances for nutrients.

8) The method as claimed in claim 1, wherein the set of target intake nutritional values are based on the personal preference, an authoritative standard, or any combination thereof.

9) The method as claimed in claim 1, wherein the food items are selected from food categories.

10) The method as claimed in claim 1, wherein the food items are grouped as breakfast, lunch, or dinner.

11) The method as claimed in claim 1, wherein the food items received from the remote electronic device represent a partial meal, partial meals, a whole meal, whole meals, or any combination thereof.

12) The method as claimed in claim 1, wherein the time period is between one day and one year.

13) The method as claimed in claim 1, wherein the food item is an uncooked food ingredient, a food ingredient cooked in a prescribed manner, a homemade dish, or a commercial product.

14) The method as claimed in claim 1, wherein the database or the computer programs or both are implemented in the remote electronic device.

15) A diet planning system, comprising: a remote electronic device, which has a input screen to receive personal preferences and food items as part of a diet menu for a time period; a display screen to display a complete diet menu for the specified time period, the total nutritional values of the food items in the diet menu, and the target intake nutritional values; a communication network to transmit data between the remote electronic device and the server; a database, which stores among other data personal preferences, target intake nutritional values, and Page nutritional values for food items; computer programs, which establish the target intake nutritional values based on the personal preference and authoritative standards, calculate the total nutritional values of the user specified food items, calculate the difference between the total nutritional values of the user specified food items and the target intake nutritional values, and select food items from the database, of which the total nutritional values match or are close to the difference calculated above, and construct a complete diet menu comprising of user specified and system selected food items for the time period.

16) The system as claimed in claim 15, wherein the remote electronic device is selected from a group consisting of a desktop computer, a laptop computer, a tablet computer, or a mobile phone.

17) The system as claimed in claim 15, wherein the communication network is wired, wireless, or a combination thereof.

18) The system as claimed in claim 15, where in the database, or the computer programs, or both are implemented in the remote electronic device. Page
